(19) United States
(12) Patent Application Publication
(10) Pub. No.: US 2016/0178817 A1
(43) Pub. Date: Jun. 23, 2016

(54) Use Of Disazo Compounds For Color Filters

(71) Applicant: CLARIANT INTERNATIONAL LTD., Muttenz (CH)

(72) Inventor: Gerald ENGEL, Kelkheim (DE)

(73) Assignee: CLARIANT INTERNATIONAL LTD., Muttenz (CH)

(21) Appl. No.: 14/906,831

(22) PCT Filed: Jul. 17, 2014
(86) PCT No.: PCT/EP2014/001958

§ 371 Date: Jan. 21, 2016

(30) Foreign Application Priority Data
Jul. 24, 2013 (DE) 10 2013 012 244.9

(51) Int. Cl. G02B 5/22; G02F 1/1335; C09D 125/14; C09B 35/031; C09D 17/00; C09D 133/08

(52) U.S. Cl. CPC G02B 5/223; C09D 17/003; C09D 133/08; C09D 125/14; C09B 35/031; G02F 1/133514; C08K 5/41

(57) ABSTRACT

Use of disazo compounds for color filters

The invention relates to the use of compounds of formula (I)

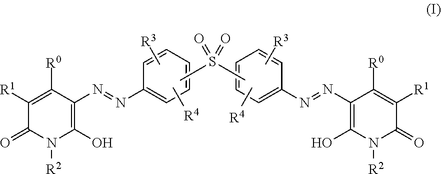

where
R⁰ is C₁-C₄ alkyl,
R¹ is H, C₁-C₄ alkyl, a sulfo group, —CO—NH—(C₁-C₄ alkyl), CN or (C₁-C₄ alkylene)sulfo,
R² is H or C₁-C₄ alkyl,
R³ is H, a sulfo group, C₁-C₄ alkyl or C₁-C₄ alkoxy,
R⁴ is H, C₁-C₄ alkyl or C₁-C₄ alkoxy.

The present invention relates to the use of certain dyes for color filters as used in liquid crystal displays or in OLED displays for example.

Liquid crystal displays (LCDs) are widely used in television sets, PC monitors, cell phones and tablet computers for example.

The functioning of LCDs is based on the following principle: Light shines first through one polarizer, then through a liquid crystal layer and subsequently through another polarizer. Under suitable electronic control and alignment by thin film transistors, the liquid crystals change the polarized light's direction of rotation, making it possible to control the brightness of the light emerging from the second polarizer and hence from the device.

Color filters are additionally incorporated in the arrangement between the polarizers in the case of colored LCD displays.

These color filters are typically situated on the surface of a transparent substrate, usually glass, in the form of numerous uniformly arrayed pixels (picture elements) in primary colors, e.g., red, green, blue (R, G, B). A single pixel is from a few micrometers to 100 micrometers in size, while the filter generally has a layer thickness between 0.2 and 5 micrometers.

As well as the components mentioned, a liquid crystal display further comprises numerous other functional components such as thin film transistors (TFTs), alignment layers and others involved in controlling the liquid crystals and hence ultimately in picture creation.

If, then, light passes through the arrangement, the liquid crystals can be set to “bright” or “dark” (or to any stage in between)—separately for each pixel—by electronic control. The respectively assigned color filter pixels are correspondingly supplied with light and a human eye looking plan at the screen sees a corresponding colored, moving or fixed image based on R, G, B.

Different ways of arranging liquid crystals, electronic control elements and polarizers are known, for example twisted nematic (TN), super twisted nematic (STN), vertical alignment (VA) and in-plane switching (IPS).

The color filter pixels can further be arranged in different defined patterns for each primary color. Separate dots of the primary colors are arranged side by side and, illuminated from behind, produce a full color image. In addition to using the three primaries red, green and blue, it is also known to use an additional color, for example yellow, to expand the color space or to use cyan, magenta and yellow as primaries.

Color filters are likewise used in W-OLED displays. A white light is initially created in these displays from pixels of organic light emitting diodes, and subsequently split by use of color filters into individual colors, for example red, green and blue.

Color filters have to meet certain requirements:

The manufacture of liquid crystal displays typically involves process temperatures of 230° C. during the steps of applying the transparent liquid crystal control electrode and the alignment layer. So the color filters used have to have high heat stability.

Further important requirements include, for example, a high contrast ratio, a high brightness for the color filter and the best possible hue.

A high contrast ratio has a positive effect on picture quality. Contrast ratio is measured by determining the intensity of light after passing through a color filter on a transparent substrate positioned between two polarizers. Contrast ratio is the ratio of the light intensities for parallel and perpendicular polarizers.

$$CR = \frac{light intensity ( parallel )}{light intensity ( perpendicular )}$$

A high level of transmission and the brightness, resulting therefrom is desirable for the color filter because it means that less light has to be irradiated into the display to produce the same level of image brightness than in the case of a less bright color filter, meaning an overall energy saving.

Color filters typically use pigmented coatings. To produce pigmented coatings, pigments are dispersed in an organic, nonaqueous solvent in the presence of dispersing assistants to form a millbase and then admixed with suitable polymeric binders (acrylate salts, acrylate esters, polyimides, polyvinyl alcohols, epoxides, polyesters, melamines, gelatin, caseins) and/or of polymerizable ethylenically unsaturated monomers and oligomers together with further auxiliaries to formulate a UV-curing colored dispersion. This photoresist, so called, is applied as a thin layer atop the carrier substrate, patterned with UV light through masks and finally developed and heat treated. Multiple repetition of these steps for the individual primary colors creates the color filter in the form of a pixel pattern.

Dyes are also being increasingly used in color filters in order that contrast, brightness, hue and transmission may each be optimized to the stipulated purpose. However, commercially available dyes in particular lack fastness, in particular thermal stability.

Patent document JP S62-180302 (1986) describes the use for color filters of various acid dyes in the form of the free acid. However, the azo compounds recited therein exhibit insufficient stability to heat. Nor is working with free acids in keeping with best workplacd health and safety practice.

Color filter colorants have to meet ever increasing demands.

Even commercially available products do not always meet all technical requirements. More particularly, there is a need for improvement with regard to heat stability, contrast and brightness on the part of the colorants used, without adverse effect on chroma and hue.

The problem addressed by the present invention was that of providing greenish yellow dyes of good heat stability for color filter applications.

It was found that dyes of general formula (I) are very useful in color filters and have a surprisingly high heat stability therein in particular. Other commercially available greenish yellow dyes do not exhibit this trait.

The invention provides a method of using compounds of formula (I) for color filters

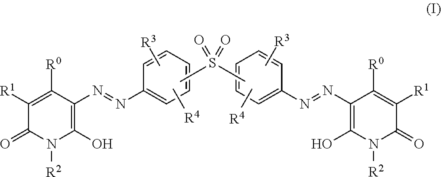

where
R⁰ is C₁-C₄ alkyl,
R¹ is H, C₁-C₄ alkyl, a sulfo group, —CO—NH—(C₁-C₄ alkyl), CN or (C₁-C₄ alkylene)sulfo,
R² is H or C₁-C₄ alkyl,
R³ is H, a sulfo group, C₁-C₄ alkyl or C₁-C₄alkoxy,
R⁴ is H, C₁-C₄ alkyl or C₁-C₄alkoxy.

The compounds of formula (I) preferably contain at least one sulfo group and more preferably contain two sulfo groups.

Preferably, R⁰ is C₁-C₂ alkyl, in particular methyl.

Preferably, R¹ is (C₁-C₄ alkylene)sulfo, in particular —CH₂-sulfo.

Preferably, R² is C₁-C₂ alkyl, in particular ethyl.

Preferably, R³ is H, a sulfo group, methyl or methoxy, in particular H.

Preferably, R⁴ is H, methyl or methoxy, in particular H.

Preferably, the position of the SO₂ bridge relative to the —N═N— groups is meta or para.

In particularly preferred compounds of the formula (I)

R⁰ is methyl,

R¹ is —CH₂-sulfo,

R² is ethyl,

R³ is H, a sulfo group, methyl or methoxy, in particular H, and

R⁴ is H, methyl or methoxy, in particular H.

A sulfo group is a group of the formula —SO₃M where M is hydrogen or a monovalent metal cation, preferably Li, Na or K, in particular H or Na.

Very particular preference is given to compounds of formula (Ia)

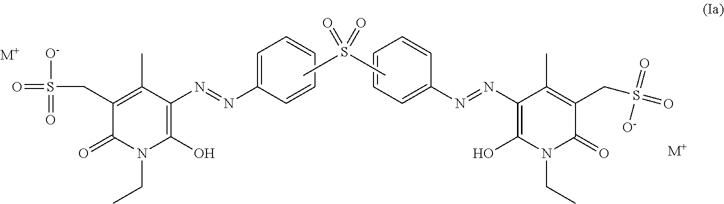

where M⁺ represents monovalent metal cations such as Li⁺, Na⁺ or K⁺ and also H, in particular Na⁺.

Preferably, the position of the SO₂ bridge relative to the —N═N— groups is meta or para, in particular para.

The compounds of formula (I) are known as such and are described in WO 2010/000779 Al as textile dyes for dyeing or printing fibrous material consisting of natural or synthetic polyamides in aqueous media only.

The formula (I) colorants described are useful in millbases and photoresists for the production of color filters. More particularly, they provide hues in the yellow greenish spectrum, which are particularly sought after in color filter duty. It is likewise possible to use the compounds of formula (I) for adjusting the desired hue of the RGB primaries, preferably for green and red.

The present invention accordingly also provides a millbase containing 0.01 to 45 wt %, preferably 2 to 20 wt % and especially 7 to 17 wt % of compounds of formula (I) in the form of a dispersion in an organic solvent.

Useful organic solvents include for example:

ethyl lactate, benzyl alcohol, 1,2,3-trichloropropane, 1,3-butanediol, 1,3-butylene glycol, 1,3-butylene glycol diacetate, 1,4-dioxane, 2-heptanone, 2-methyl-1,3-propanediol, 3,5,5-trimethyl-2-cyclohexen-1-one, 3,3,5-trimethylcyclohexanone, 3-ethoxyethylpropionate, 3-methyl-1,3-butanediol, 3-methoxy-3-methyl-1-butanol, 3-methoxy-3-methylbutyl acetate, 3-methoxybutanol, 3-methoxybutyl acetate, 4-heptanone, m-xylene, m-diethylbenzene, m-dichlorobenzene, N,N-dimethylacetamide, N,N-dimethylformamide, n-butyl alcohol, n-butylbenzene, n-propyl acetate, o-xylene, o-chlorotoluene, o-diethylbenzene, o-dichlorobenzene, p-chlorotoluene, p-diethylbenzene, sec-butylbenzene, tert-butylbenzene, gamma-butyrolactone, isobutyl alcohol, isophorone, ethylene glycol diethyl ether, ethylene glycol dibutyl ether, ethylene glycol monoisopropyl ether, ethylene glycol monoethyl ether, ethylene glycol monoethyl ether acetate, ethylene glycol mono-tert-butyl ether, ethylene glycol monobutyl ether, ethylene glycol monobutyl ether acetate, ethylene glycol monopropyl ether, ethylene glycol monohexyl ether, ethylene glycol monomethyl ether, ethylene glycol monomethyl ether acetates, diisobutylketone, diethylene glycol diethyl ether, diethylene glycol dimethyl ether, diethylene glycol monoisopropyl ether, diethylene glycol monoethyl ether acetate, diethylene glycol monobutyl ether, diethylene glycol monobutyl ether acetate, diethylene glycol monomethyl ether, cyclohexanol, cyclohexanol acetate, cyclohexanone, dipropylene glycol methyl ether, dipropylene glycol methyl ether acetate, dipropylene glycol monoethyl ether, dipropylene glycol monobutyl ether, dipropylene glycol monopropyl ether, dipropylene glycol monomethyl ether, diacetone alcohol, triacetylglycerol, tripropylene glycol monobutyl ether, tripropylene glycol monomethyl ether, propylene glycol diacetate, propylene glycol phenyl ether, propylene glycol monoethyl ether, propylene glycol monoethyl ether acetates, propylene glycol monobutyl ether, propylene glycol monopropyl ether, propylene glycol monomethyl ether, propylene glycol monomethyl ether acetate, propylene glycol monomethyl ether propionates, benzyl alcohol, methyl isobutyl ketone, methylcyclohexanol, n-amyl acetate, n-butyl acetate, isoamyl acetate, isobutyl acetate, propyl acetates, dibasic ester (DBE).

Of particular advantage are ethyl lactate, propylene glycol monomethyl ether acetate (methoxypropyl acetate), propylene glycol monoethyl ether acetate, ethylene glycol monomethyl ether acetate, ketones such as cyclohexanone or alcohols such as n-butanol or benzyl alcohol.

The organic solvents can be used alone or mixed with one another.

The millbase of the present invention may also contain dispersing assistants.

Useful dispersing assistants include commonly known compounds, for example polymeric dispersing assistants. These are typically polymers or copolymers based on polyesters, polyacrylates, polyurethanes and also polyamides. Wetting agents may further be used, examples being anionic or nonionic wetting agents. The recited wetting agents and dispersing assistants can be used individually or in combination. Their amount is advantageously from 2 to 100 wt %, preferably from 10 to 50 wt %, based on the weight of compounds of formula (I).

To produce the millbases, the compounds of formula (I) are subjected to a dispersing operation, or the compounds of formula (I) are dissolved in a suitable solvent, for example N-methylpyrrolidone or dimethylformamide, and imported into the millbases or photoresists.

When the compounds of formula (I) are used in the form of a dispersed colorant in a millbase, a small primary particle size is advantageously first set in a suitable manner. Particularly suitable primary particle sizes are less than 60 nm and preferably less than 40 nm in the d50 value. It is similarly advantageous to set a narrow particle size distribution.

The particle size distribution of compounds of formula (I) after comminution preferably approximates a Gaussian distribution in which the standard deviation sigma is preferably less than 30 nm and more preferably less than 20 nm. The standard deviations are generally between 5 and 30 nm, preferably between 6 and 25 nm and particularly between 7 and 20 nm.

The standard deviation sigma (σ) corresponds to the positive square root of the variance. The variance v is the sum total of the squared deviations from the mean, divided by the number of samples minus 1. It is further advantageous for the d95 value of the comminuted particles to be not more than 70 nm. The length to width ratio of the comminuted particles is preferably between 2:1 and 1:1.

One way to achieve the fine state of subdivision is salt kneading with a crystalline inorganic salt in the presence of an organic solvent. Useful crystalline inorganic salts include, for example, aluminum sulfate, sodium sulfate, calcium chloride, potassium chloride or sodium chloride, preferably sodium sulfate, sodium chloride and potassium chloride. Useful organic solvents include, for example, ketones, esters, amides, sulfones, sulfoxides, nitro compounds, mono-, bis- or tris-hydroxy-C₂-C₁₂-alkanes which may be substituted with C₁-C₈ alkyl and one or more hydroxyl groups. Particular preference is given to water-miscible high-boiling organic solvents based on monomeric, oligomeric, polymeric C₂-C₃ alkylene glycols, e.g., diethylene glycol, diethylene glycol monomethyl ether, diethylene glycol monoethyl ether, triethylene glycol, triethylene glycol monomethyl ether, triethylene glycol monoethyl ether, dipropylene glycol, dipropylene glycol monomethyl ether, dipropylene glycol monoethyl ether, propylene glycol monomethyl ether, propylene glycol monoethyl ether and liquid polyethylene glycols and polypropylene glycols, n-methylpyrrolidone and also triacetin, dimethylformamide, dimethylacetamide, ethyl methyl ketone, cyclohexanone, diacetone alcohol, butyl acetate, nitromethane, dimethyl sulfoxide and sulfolane.

The weight ratio between the inorganic salt and the compound of formula (I) is preferably in the range from 2:1 to 10:1 and particularly in the range from 3:1 to 7:1.

The weight ratio between the organic solvent and the inorganic salt is preferably in the, range from 1 m1:10 g to 2 m1:7 g.

The weight ratio between the organic solvent and the sum total of inorganic salt and compound (I) is preferably in the range from 1 ml:2 g to 1 ml:10 g.

The temperature during kneading may be between 40 and 140° C., preferably 60 to 120° C. Kneading time is advantageously in the range from 4 h to 32 h, preferably from 8 h to 20 h.

After salt kneading, the inorganic salt and the organic solvent is advantageously removed by washing with water and the comminuted colorants thus obtained are dried in a conventional manner.

The material obtained following the conversion into a fine state of subdivision may optionally be subjected in the form of a suspension, filter cake or dry material to a solvent aftertreatment in order to obtain a more homogenous particle shape without marked increase in the particle size. Preference is given to using steam-volatile solvents such as alcohols and aromatic solvents, more preferably branched or unbranched C₁-C₆ alcohols, toluene, xylene, chlorobenzene, dichlorobenzene, nitrotoluene or nitrobenzene usually under elevated temperature, for example at up to 200° C., and optionally under elevated pressure.

The invention further provides a bindered color dispersion containing 0.01 to 40 wt %, preferably 0.1 to 30 wt %, particularly 1 to 20 wt %, of compounds of formula (I) in the form of a dispersion in at least one organic solvent, at least one polymeric binder and optionally further auxiliaries.

The bindered color dispersion is advantageously obtained by mixing the above-described millbase with the other components mentioned.

Useful polymeric binders include, for example, acrylate salts, acrylate esters, polyimides, polyvinyl alcohols, epoxides, polyesters, melamines, gelatin, caseins and polymerizable ethylenically unsaturated monomers and oligomers, preferably those which crosslink either thermally or under the effect of UV light and free-radical initiators. The amount of polymeric binders is advantageously from 5 to 90 wt % and preferably from 20 to 70 wt % based on the total amount of all nonvolatile constituents of the color dispersion. Nonvolatile constituents are the compounds of formula (I), the polymeric binders and the further auxiliaries. Volatile constituents are the organic solvents which are volatile under the baking temperatures used.

Useful organic solvents include the solvents mentioned above for the millbase. They are advantageously present in an amount of from 10 to 90 wt %, preferably from 20 to 80 wt %, based on the overall amount of the color dispersion.

Useful further auxiliaries include, for example, crosslinkers and free-radical initiators, flow control agents, defoamers and deaerators. They are advantageously present in an amount of from 0 to 10 wt %, preferably from 0 to 5 wt %, based on the overall amount of the color dispersion.

When further auxiliaries are used, a lower limit of 0.01 wt %, preferably 0.1 wt %, is advantageous, based on the overall amount of the color dispersion.

The color dispersion of the present invention may be cured by UV radiation or thermally, advantageously after application atop their carrier substrate. A photoresist is typically cured using UV radiation.

### COLOR FILTER USE EXAMPLES

### Use Example 1

10.0 g of the compound of formula (1)

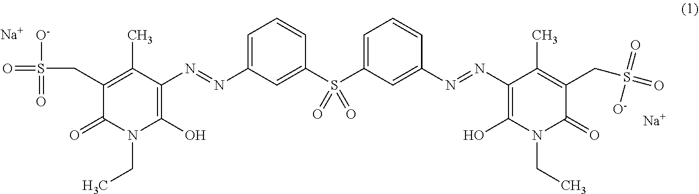 [SMILES: [Na+] ; CCn1c(O)c(/N=N/c2cccc(S(=O)(=O)c3cccc(/N=N/c4c(C)c(CS(=O)(=O)[O-])c(=O)n(CC)c4O)c3)c2)c(C)c(CS(=O)(=O)[O-])c1=O ; [Na+]]

prepared as described in Example 1 of WO 2010/000779 A1 are dispersed in a paint shaker beaker with 72.5 g of methoxypropyl acetate (PGMEA), 5.0 g of n-butanol and also 12.5 g of Disperbyk® 2001 (BYK-Chemie, polymeric dispersing assistant solution) by stirring. A mixture of 250 g of zirconium oxide beads (0.3 mm) is followed by dispersal in a dispersing device from Lau (Dispermat) for 3 hours. The millbase obtained is separated from the beads by filtration.

20.0 g of this millbase are mixed with 20.5 g of a 10 wt % solution of Joncryl® 611 (styrene-acrylate resin, BASF AG) in PGMEA by shaking for 10 minutes without beads. The dispersion was filtered.

The color dispersion obtained is applied by means of a spincoater (POLOS Wafer Spinner) atop glass plates (SCHOTT, laser cut, 10×10 cm) in a layer thickness such that a color coordinate y=0.480 can be used as reference for use of illuminant C. The layer thickness was about 1.5 micrometers.

The glass plates were allowed to flash off and then dried for 10 min at 80° C. in a circulating air drying cabinet (from Binder). The glass plates are measured for the prebake values of the color coordinates (x, y, Y, and also CIELAB, Datacolor 650 spectrophotometer, illuminant C, 2° observer), transmission curves (ditto) and contrast values (Contrast Tester Tsubosaka CT-1).

The glass plates are subsequently subjected to a heat treatment at 250° C. for 1 h in the circulating air drying cabinet and remeasured to obtain the postbake values. The hue change between prebake and postbake is ΔE=4.6.

The coated glass plates were further examined under an optical microscope (Nikon Eclipse® LN/100) for the presence of coarse agglomerates. To this end, the foreign bodies visible in transmitted light were counted in three micrographs at a time at 200-fold magnification. The lower the particle count, the better the compatibility of the dye with the film.

The classifications here have the following meanings:

A: fewer than 5 particles

B: 5 to 20 particles

C: 20-100 particles (acceptance limit)

D: more than 100 particles

The results are shown in table 1.

### Use Example 2

Use Example 1 is repeated except that the compound of formula (I) is replaced by the compound of formula (2)

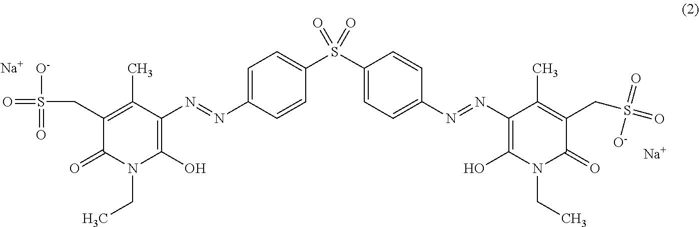 [SMILES: [Na+] ; CCn1c(O)c(/N=N/c2ccc(S(=O)(=O)c3ccc(/N=N/c4c(C)c(CS(=O)(=O)[O-])c(=O)n(CC)c4O)cc3)cc2)c(C)c(CS(=O)(=O)[O-])c1=O ; [Na+]]

prepared as described in Example 2 of WO 2010/000779 A1.

Millbase and color dispersion are prepared similarly to Use Example 1.

The hue change between prebake and postbake is ΔE=3.3.

### Use Example 3

Use Example 1 is repeated except that the compound of formula (I) is replaced by the compound of formula (3)

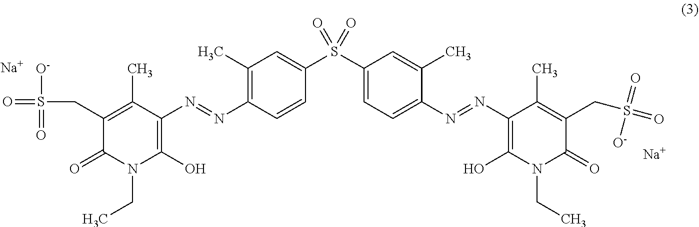 [SMILES: [Na+] ; CCn1c(O)c(/N=N/c2ccc(S(=O)(=O)c3ccc(/N=N/c4c(C)c(CS(=O)(=O)[O-])c(=O)n(CC)c4O)c(C)c3)cc2C)c(C)c(CS(=O)(=O)[O-])c1=O ; [Na+]]

prepared as described in Example 3 of WO 2010/000779 A1.

Millbase and color dispersion are prepared similarly to Use Example 1.

The'hue change between prebake and postbake is ΔE=4.2.

### Use Example 4

Use Example 1 is repeated except that the compound of formula (I) is replaced by the compound of formula (4)

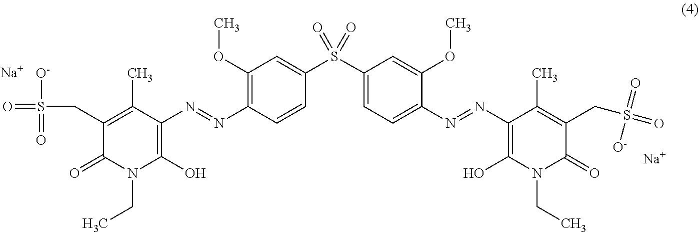 [SMILES: [Na+] ; CCn1c(O)c(/N=N/c2ccc(S(=O)(=O)c3ccc(/N=N/c4c(C)c(CS(=O)(=O)[O-])c(=O)n(CC)c4O)c(OC)c3)cc2OC)c(C)c(CS(=O)(=O)[O-])c1=O ; [Na+]]

prepared as described in Example 4 of WO 2010/000779 A1.

Millbase and color dispersion are prepared similarly to Use Example 1.

The hue change between prebake and postbake is ΔE=5.1.

### Comparative Examples

Use Example 1 is repeated except that the inventive compounds are replaced by other greenish yellow dyes.

The C.I. Disperse Yellow 65 used was prepared by the following method: 20.2 g (80 mmol) of 7-amino-anthra[9,1-cd]isothiazol-6-one and 11.1 ml of triethylamine are introduced into 100 ml of toluene. 9.3 ml (80 mmol) of benzoyl chloride are added dropwise at 80° C. over 20 minutes with stirring. After 4 hours of refluxing, the mixture is cooled down to room temperature and filtered off and the presscake is washed with 6*100 ml of hot water. After drying in vacuo at 60° C. 26.8 g of product are obtained.

Table 1 shows the results of the inventive and comparative examples.

The relative contrast ratio CR reltes to the color dispersion as per Use Example 2 (100%).

The values x, y and Y, as noted above, refer to the measured color coordinates in the CIE-Yxy standardized color space where Y is a measure of brightness. Delta E refers to the color change between prebake and postbake according to the following formula of the CIELAB color system:

ΔE=\sqrt{(ΔL²+Δa²+Δb²),}
where ΔL=L_{postbake}−L_{prebake}
   Δa=a_{postbake}−a_{prebake}
and Δb=b_{postbake}−b_{prebake}.

a, b and L therein refer to the measured color coordinates in the CIELAB color system.

TABLE 1

| | | | |
|---|---|---|---|
| | | Rel. | |
| x | Y | CR | Delta E |

| | | | |
|---|---|---|---|
| | Particle | at y = 0.480 | Prebake to |
| Compound | (microscope) | (postbake) | postbake |

Inventive examples

| | | | | | |
|---|---|---|---|---|---|
| Use Example 1 | B | 0.413 | 81.0 | 100% | 4.6 |
| Use Example 2 | B | 0.412 | 81.1 | 100% | 3.3 |
| Use Example 3 | B | 0.420 | 79.3 | 97% | 4.2 |
| Use Example 4 | A | 0.429 | 78.2 | 110% | 5.1 |

Comparative examples:

| | | | | | |
|---|---|---|---|---|---|
| C.I. Disperse Yellow 65 | D | 0.492 | 17.1 | 2% | 50.5 |
| C.I. Vat Yellow 26, | C | 0.462 | 35.6 | 1% | 35.1 |
| prepared as described | | | | | |
| in Example 2 of DE | | | | | |
| 469019 | | | | | |

The glass plates each show greenish yellow colorations. The transmission curves of the compounds described exhibit increased transmission between 440 and 490 nm.

Compared with known greenish⁻yellow dyes, the compounds of the present invention display a distinctly smaller color change on heating. The transmission curves of the comparative examples further flatten off significantly on heating. The compounds of the present invention can accordingly be described as distinctly more heat-stable.

The compounds of the present invention similarly display better compatibility with the application system and, as a result, on dispersal, fewer foreign particles, higher brightness Y, higher contrast values coupled with distinctly better heat stability.

Use Examples with Micronized Compounds:

### Example 5

### K1 (Micronized Compound)

In a laboratory kneader (Werner & Pfleiderer, 300 ml) 16.0 g of the compound of formula (2) prepared as described in Example 2 of WO 2010/000779 A1

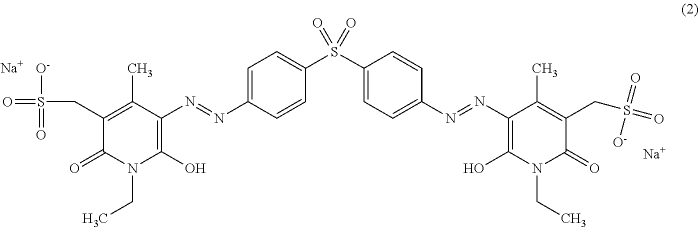 [SMILES: [Na+] ; CCn1c(O)c(/N=N/c2ccc(S(=O)(=O)c3ccc(/N=N/c4c(C)c(CS(=O)(=O)[O-])c(=O)n(CC)c4O)cc3)cc2)c(C)c(CS(=O)(=O)[O-])c1=O ; [Na+]]

are kneaded with 96 g of sodium chloride and 30 ml of diethylene glycol at 80° C. for 18 h. The kneading dough is stirred in 0.9 l of cold water for 30 min and the composition is subsequently filtered off. The filter cake is treated again for 30 min with 0.9 l of cold demineralized water while stirring. After filtration, the colorant is washed with water and dried in vacuo to obtain 12.5 g of a yellow solid K1.

The colorant obtained has a median particle size d₅₀=38 nm and a d₉₅ value of 64 nm with a standard deviation σ of 13 nm.

Length to width ratio: 1.34:1

Millbase and color dispersion are prepared similarly to Use Example 1.

### Example 6

### K2 (Micronized Compound)

Example 5 is repeated except that compound (2) is replaced by the compound of formula (4) prepared as described in Example 4 of WO 2010/000779 A1:

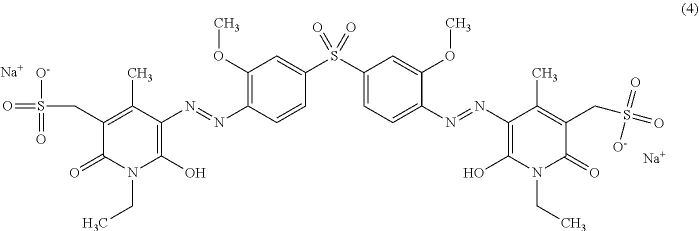 [SMILES: [Na+] ; CCn1c(O)c(/N=N/c2ccc(S(=O)(=O)c3ccc(/N=N/c4c(C)c(CS(=O)(=O)[O-])c(=O)n(CC)c4O)c(OC)c3)cc2OC)c(C)c(CS(=O)(=O)[O-])c1=O ; [Na+]]

The colorant obtained has a median particle size d₅₀=39 nm and a d₉₅ value of 65 nm with a standard deviation σ of 14 nm.

Length to width ratio: 1.33:1

Millbase and color dispersion are prepared similarly to Use Example 1.

### Comparative Example K3

Example 5 is repeated except that compound (2) is replaced by C.I. Disperse Yellow 65.

The colorant obtained has a median particle size d₅₀=42 nm and a d₉₅ value of 72 nm with a standard deviation σ of 15 nm.

Length to width ratio: 1.35:1

Millbase and color dispersion are prepared similarly to Use Example 1.

Results see table 2:

TABLE 2

| | | | |
|---|---|---|---|
| Particle | x | Y | Rel. CR |

| | | |
|---|---|---|
| Compound | (microscope) | at y = 0.480 (postbake) |

Inventive examples

| | | | | |
|---|---|---|---|---|
| Use Example 2 | B | 0.412 | 81.1 | 100% |
| Use Example 5 (K1) | B | 0.413 | 81.4 | 138% |
| Use Example 6 (K2) | B | 0.426 | 79.1 | 152% |

1. A method of for producing a color filter comprising the step of adding at least one compound of formula (I) to the color filter during manufacture of the color filter: 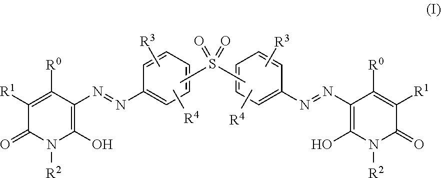
wherein
R⁰ is C₁-C₄ alkyl,
R¹ is H, C₁-C₄ alkyl, a sulfo group, —CO—NH—(C₁-C₄ alkyl), CN or (C₁-C₄ alkylene)sulfo,
R² is H or C₁-C₄ alkyl,
R³ is H, a sulfo group, C₁-C₄ alkyl or C₁-C₄ alkoxy,
R⁴ is H, C₁-C₄ alkyl or C₁-C₄ alkoxy.

2. The method as claimed in claim 1, wherein the the at least one compound of formula (I) contains at least one sulfo group.

3. The method as claimed in claim 1, wherein
R⁰ is C₁-C₂ alkyl.

4. The method as claimed in, claim 1, wherein
R¹ is (C₁-C₄ alkylene)sulfo.

5. The method as claimed in claim 1, wherein
R² is C₁-C₂ alkyl.

6. The method as claimed in claim 1, wherein
R³ is H, a sulfo group, methyl or methoxy.

7. The method as claimed in claim 1, wherein
R⁴ is H, methyl or methoxy.

8. The method as claimed in claim 1, wherein the position of the SO₂ bridge relative to the —N═N— groups is meta or para.

9. The method as claimed in claim 1, wherein
R⁰ is methyl,
R¹ is —CH₂-sulfo,
R² is ethyl,
R³ is H, a sulfo group, methyl or methoxy, and
R⁴ is H, methyl or methoxy.

10. The method as claimed in claim 1, wherein the color filter is in liquid crystal displays or in OLED displays.

11. A millbase containing 0.01 to 45 wt % of a compound of formula (I) 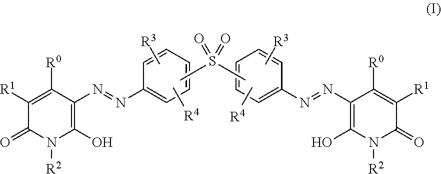
wherein
R⁰ is C₁-C₄ alkyl,
R¹ is H, C₁-C₄ alkyl, a sulfo group, —CO—NH—(C₁-C₄ alkyl), CN or (C₁-C₄ alkylene)sulfo,
R² is H or C₁-C₄ alkyl,
R³ is H, a sulfo group, C₁-C₄ alkyl or C₁-C₄ alkoxy,
R⁴ is H, C₁-C₄ alkyl or C₁-C₄alkoxy
in the form of a dispersion in an organic solvent.

12. The millbase as claimed in claim 11 containing 7 to 17 wt % of a compound of formula (I) as a dispersion in an organic solvent.

13. The millbase as claimed in claim 11 wherein the compound of formula (I) has a primary particle size of less than 60 nm.

14. A bindered color dispersion containing 0.01 to 40 wt % of a compound of formula (I) 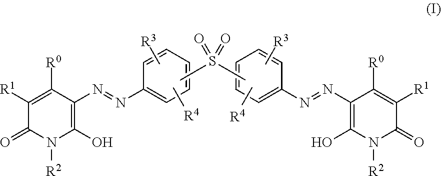
wherein
R⁰ is C₁-C₄ alkyl,
R¹ is H, C₁-C₄ alkyl, a sulfo group, —CO—NH—(C₁-C₄ alkyl), CN or (C₁-C₄ alkylene)sulfo,
R² is H or C₁-C₄ alkyl,
R³ is H, a sulfo group, C₁-C₄ alkyl or C₁-C₄ alkoxy,
R⁴ is H, C₁-C₄ alkyl or C₁-C₄alkoxy
in the form of a dispersion in at least one organic solvent, at least one polymeric binder and optionally further auxiliaries.

15. The bindered color dispersion as claimed in claim 14 containing 1 to 20 wt % of a compound of formula (I).

16. The method as claimed in claim 9, wherein
R³ is H.

17. The method as claimed in claim 9, wherein
R⁴ is H.
